(19) United States
(12) Patent Application Publication
(10) Pub. No.: US 2017/0043930 A1
(43) Pub. Date: Feb. 16, 2017

(54) FOAM TRAY FOR FOOD PACKAGING AND METHOD FOR MANUFACTURING THE SAME

(71) Applicant: LG HAUSYS, LTD., Seoul (KR)

(72) Inventors: Byung-Joo JEON, Seoul (KR); Eung-Kee LEE, Anyang-si (KR); Chul-June CHOI, Cheongju-si (KR); Myeong-Hee KIM, Anyang-si (KR); Ji-Mun KIM, Seoul (KR); Seung-Wook JI, Seoul (KR); Gun-Pyo PARK, Seoul (KR); Kwon-Bin SONG, Incheon (KR)

(21) Appl. No.: 15/307,048

(22) PCT Filed: Apr. 1, 2015
(86) PCT No.: PCT/KR2015/003241

§ 371 Date: Oct. 27, 2016

(30) Foreign Application Priority Data
Apr. 29, 2014 (KR) 10-2014-0051375

(51) Int. Cl. B65D 81/26; C08J 5/18; B65D 1/40; B65D 1/34; B65D 65/46

(52) U.S. Cl. CPC B65D 81/264; B65D 1/34; B65D 65/466; B65D 1/40; C08J 5/18; C08J 2367/04; C08J 2403/02

(57) ABSTRACT

Provided are a foam tray for food packaging including a laminated structure of a first foaming layer having an internal moisture absorbent property, and a second foaming layer having an external moisture barrier property, wherein the first foaming layer and the second foaming layer include a biodegradable polymer, and a method for manufacturing the same.

### FIELD OF THE INVENTION

The present disclosure relates to a foam tray for food packaging and a method for manufacturing the same.

### BACKGROUND OF THE INVENTION

Refrigerated products for sale, for example, foods such as seafood and meat experience rapid decline in the freshness of contents due to microorganism propagation as well as experience decline in the product values as time passes during distribution with moisture or blood oozing out therefrom.

As means for solving such problems, a method of preparing a special pad for moisture absorption, spreading the pad on a foam tray, and packing contents that may produce moisture has been proposed. However, such a special pad for moisture absorption is an expensive material causing a higher financial burden, and the method also has a disadvantage in terms of inconvenience since the pad needs to be separately prepared and used, and therefore, additional processes are required.

As another method, holes through which moisture may pass are made on an internal surface of a foam tray so that moisture produced from a food is removed through the open holes. However, such as a method has a manufacturing limit in forming open holes on the surface, and has a disadvantage in that a moisture absorbent property is not sufficiently exhibited.

In view of the above, development of packing materials having excellent durability while maintaining values of the contents during distribution and storage has been recently required.

### SUMMARY OF THE INVENTION

One embodiment of the present disclosure is directed to providing a foam tray having excellent durability, harmless to the human body while maintaining freshness and values of contents, and harmless to the environment when disposed.

Another embodiment of the present disclosure is directed to a method for manufacturing the foam tray capable of simplifying a manufacturing process.

One embodiment of the present disclosure provides a foam tray for food packaging including a laminated structure of a first foaming layer having an internal moisture absorbent property, and a second foaming layer having an external moisture barrier property, wherein the first foaming layer and the second foaming layer include a biodegradable polymer.

The first foaming layer may include the biodegradable polymer in approximately 50% by weight to approximately 90% by weight, and may include starch in approximately 10% by weight to approximately 50% by weight.

The starch may include one or more selected from the group consisting of corn starch, wheat starch, sweet potato starch, rice starch, potato starch, tapioca starch and combinations thereof.

The second foaming layer may include the biodegradable polymer in approximately 95% by weight to approximately 100% by weight.

The biodegradable polymer may include one or more selected from the group consisting of polylactic acid (PLA), polyhydroxyalkanoate (PHA), polybutylene succinate (PBS), polybutylene adipate-co-butylene succinate (PBSA), polybutylene adipate terephthalate (PBAT), polyhydroxybutyrate valerate (PHBV), polyvinyl alcohol (PVA), polyglycolic acid (PGA), poly(ester-amide) (PEA), poly(ester-urethane) (PEU) and combinations thereof.

The first foaming layer and the second foaming layer may include an identical biodegradable polymer.

The first foaming layer may have a thickness of approximately 1 mm to approximately 3 mm.

The second foaming layer may have a thickness of approximately 1 mm to approximately 3 mm.

The first foaming layer may have an independent bubble fraction of approximately 50% to approximately 80%.

The second foaming layer may have an independent bubble fraction of approximately 70% to approximately 95%.

Another embodiment of the present disclosure provides a method for manufacturing a foam tray for food packaging including preparing a composition for preparing a first foaming layer including a biodegradable polymer in approximately 50% by weight to approximately 90% by weight; preparing a composition for preparing a second foaming layer including a biodegradable polymer in approximately 95% by weight to approximately 100% by weight; injecting the composition for preparing a first foaming layer to a first extruder, and injecting the composition for preparing a second foaming layer to a second extruder; and preparing a first foaming layer and a second foaming layer by continuously foaming and extruding the composition for preparing a first foaming layer and the composition for preparing a second foaming layer, respectively, and simultaneously laminating the first foaming layer and the second foaming layer.

The composition for preparing a first foaming layer may further include starch in approximately 10% by weight to approximately 50% by weight.

The composition for preparing a first foaming layer and the composition for preparing a second foaming layer may further include a foaming agent in 1% by weight to 5% by weight.

The composition for preparing a first foaming layer and the composition for preparing a second foaming layer may include an identical biodegradable polymer.

The first extruder and the second extruder may have cylinder temperatures of approximately 140° C. to approximately 230° C.

### BRIEF DESCRIPTION OF THE DRAWINGS

FIG. 1 schematically shows a sectional view of a foam tray for food packaging according to one embodiment of the present disclosure; and

FIG. 2 is a process flow chart showing a method for manufacturing a foam tray for food packaging according to one embodiment of the present disclosure.

### DETAILED DESCRIPTION OF THE EMBODIMENTS

Hereinafter, embodiments of the present disclosure will be described in detail. However, these are for illustrative purposes only, and the scope of the present disclosure is not limited thereto, and the scope of the present disclosure is defined by the appended claims.

In the drawings, thicknesses are enlarged in order to clearly show various layers and regions, and for the convenience of description, thicknesses of some layers and regions are exaggerated.

Hereinafter, a foam tray for food packaging and a method for manufacturing the same will be described in detail with reference to the attached drawings.

Foam Tray for Food Packaging

One embodiment of the present disclosure provides a foam tray for food packaging including a laminated structure of a first foaming layer having an internal moisture absorbent property, and a second foaming layer having an external moisture barrier property, wherein the first foaming layer and the second foaming layer include a biodegradable polymer.

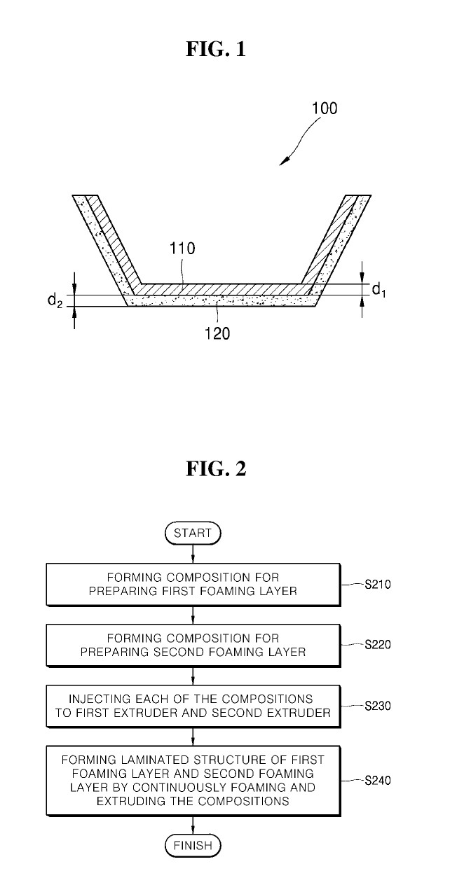

FIG. 1 schematically shows a sectional view of a foam tray for food packaging according to one embodiment of the present disclosure. The foam tray for food packaging 100 is manufactured to a container form with an open top, and a subject for packaging is packed as being placed on a surface adjoining the first foaming layer 110. In the present specification, the specific region adjoining the first foaming layer 110 is referred to as ‘inside’, and the specific region adjoining the second foaming layer 120 is referred to as ‘outside’.

Referring to FIG. 1, the foam tray for food packaging 100 may include a structure laminating the first foaming layer 110 and the second foaming layer 120 from the top, and the first foaming layer 110 may have an internal moisture absorbent property, and the second foaming layer 120 may have an external moisture barrier property.

The first foaming layer having an internal moisture absorbent property means that the first foaming layer has a main role of absorbing moisture produced inside the foam tray, however, the role is not limited thereto. For example, the first foaming layer may also have an incident role of blocking moisture trying to penetrate from the outside while having a main role of absorbing moisture produced from a food placed on a surface adjoining the first foaming layer.

In addition, the second foaming layer having an external moisture barrier property means that the second foaming layer has a main role of blocking moisture trying to penetrate from outside the foam tray, however, the role is not limited thereto. For example, the second foaming layer may also have an incident role of absorbing some moisture produced inside while having a main role of blocking moisture trying to penetrate from the outside adjoining the second foaming layer.

By the first foaming layer 110 having an internal moisture absorbent property and the second foaming layer 120 having an external moisture barrier property, foods, the contents, are capable of being kept fresh, and propagation of microorganisms that are harmful to the human body is capable of being prevented.

The first foaming layer may include the biodegradable polymer in approximately 50% by weight to approximately 90% by weight, and may include starch in approximately 10% by weight to approximately 50% by weight.

Generally, in food packaging materials, surfactants such as anion sulfonates, and the like, may be added to raw materials for absorbing moisture produced from the contents, however, if these smear the foods, harmfulness dangerous to the human body may be caused. In view of the above, the first foaming layer may provide food packaging means that is environmental-friendly and harmless to the human body while having a moisture absorbent property may be provided by including starch and a biodegradable polymer that are harmless to the human body.

When the first foaming layer includes starch in less than approximately 10% by weight, a moisture absorbent property declines and freshness inside the foam tray is difficult to be maintained for a long period of time, and when including starch in greater than approximately 50% by weight, starch is difficult to be dispersed, which may cause concern of mechanical strength and foam magnification decline.

In addition, when the first foaming layer includes the biodegradable polymer in less than approximately 50% by weight, strength required for food packaging is difficult to secure and foam magnification may decline, and including the biodegradable polymer in greater than approximately 90% by weight has a problem in that a moisture absorbent property declines and freshness inside the foam tray is not maintained for a long period of time.

The first foaming layer may include starch for effectively absorbing moisture internally produced, and the starch may include one or more selected from the group consisting of corn starch, wheat starch, sweet potato starch, rice starch, potato starch, tapioca starch and combinations thereof. Specifically, the first foaming layer may include corn starch, which is advantageous in terms of material supply and demand, and cost reduction.

The foam tray for food packaging includes a laminated structure of the first foaming layer and the second foaming layer, and the second foaming layer may have a role of blocking moisture penetrating from the outside. Specifically, the second foaming layer may include a biodegradable polymer in approximately 95 to approximately 100% by weight. Unlike the first foaming layer, the second foaming layer does not include starch, and as a result, the second foaming layer may block moisture from the outside corresponding to the first foaming layer absorbing moisture internally produced, and may secure rigidity against external shock.

When the second foaming layer includes a biodegradable polymer in the above mentioned range, mechanical strength against external shock may be secured, the process is readily controlled, and proper foam magnification may be secured.

The first foaming layer and the second foaming layer include a biodegradable polymer, and the first foaming layer may enhance dispersibility of the starch and thereby secure an excellent moisture absorbent property by including the biodegradable polymer, and the second foaming layer may obtain excellent strength and an effect of blocking moisture from the outside by including the biodegradable polymer.

Specifically, the biodegradable polymer is a polymer degradable by microorganisms and the like, and may include one or more selected from the group consisting of polylactic acid (PLA), polyhydroxyalkanoate (PHA), polybutylene succinate (PBS), polybutylene adipate-co-butylene succinate (PBSA), polybutylene adipate terephthalate (PBAT), polyhydroxybutyrate valerate (PHBV), polyvinyl alcohol (PVA), polyglycolic acid (PGA), poly(ester-amide) (PEA), poly(ester-urethane) (PEU) and combinations thereof.

The first foaming layer and the second foaming layer may include an identical biodegradable polymer. In this case, there is an advantage in connecting the two layers when laminating the first foaming layer and the second foaming layer, and when disposing the foam tray including the same, the foam tray may be buried in the soil without separating each layer, and disposed environmentally friendly.

For example, the first foaming layer may include polylactic acid (PLA), and when including starch therein as well, the starch may be dispersed into the first foaming layer due to excellent compatibility, which may maximize a moisture absorbent property. At the same time, the second foaming layer may also include polylactic acid (PLA). In this case, the polylactic acid (PLA) performs a role of blocking moisture penetrating from the outside, and there may be an advantage in the connection when being laminated with the first foaming layer.

The foam tray for food packaging includes a laminated structure of the first foaming layer and the second foaming layer, and the first foaming layer and the second foaming layer may be each formed to a thickness of approximately 1 mm to approximately 3 mm.

The first foaming layer having a thickness (d1) of less than approximately 1 mm has problems in that moisture internally produced is not effectively absorbed, and mechanical strength decreases, and the thickness of greater than approximately 3 mm may lead to excessive spending of manufacturing costs, and may cause a problem of declining processibility such as cutting and thermoforming due to the high thickness.

The second foaming layer having a thickness (d2) of less than approximately 1 mm may weaken bearing power and durability of the foam tray, and may cause concern of not effectively blocking moisture inflowing from the outside, and the thickness of greater than approximately 3 mm may lead to excessive spending of manufacturing costs, and may cause a problem of declining processibility such as cutting and thermoforming due to the high thickness.

The first foaming layer includes bubbles, and may have an independent bubble fraction of approximately 50% to approximately 80%. When the independent bubble fraction of the first foaming layer satisfies the above-mentioned range, moisture produced inside the foam tray is capable of being effectively absorbed structurally.

The independent bubble fraction means a volume ratio of bubbles having a closed structure among a plurality of bubbles, and the closed structure represents an independently closed structure without bubble opening, and on the other hand, a structure in which bubbles are open without being independently closed is referred to as an open structure.

The second foaming layer includes bubbles, and may have an independent bubble fraction of approximately 70% to approximately 95%. When the independent bubble fraction of the second foaming layer satisfies the above-mentioned range, sufficient rigidity for protecting the contents from external shock may be secured while effectively blocking moisture inflowing from the outside.

By the foam tray for food packaging including a laminated structure of the first foaming layer and the second foaming layer, and the first foaming layer and the second foaming layer being laminated, an effect of absorbing moisture produced inside and an effect of blocking moisture penetrating from the outside may be obtained at the same time, and sufficient rigidity for protecting the contents from external shock may be secured.

Method for Manufacturing Foam Tray for Food Packaging

Another embodiment of the present disclosure provides a method for manufacturing a foam tray for food packaging including preparing a composition for preparing a first foaming layer including a biodegradable polymer in approximately 50% by weight to approximately 90% by weight; preparing a composition for preparing a second foaming layer including a biodegradable polymer in approximately 95% by weight to approximately 100% by weight; injecting the composition for preparing a first foaming layer to a first extruder, and injecting the composition for preparing a second foaming layer to a second extruder; preparing a first foaming layer and a second foaming layer by continuously foaming and extruding the composition for preparing a first foaming layer and the composition for preparing a second foaming layer, respectively, and simultaneously laminating the first foaming layer and the second foaming layer.

Generally, in a foam having a laminated structure, each layer is prepared and then the layers are laminated using separate connecting facilities or connecting processes. This requires separate facilities or processes, which leads to problems in that manufacturing costs increase and manufacturing processes become complicated. In view of the above, the method for manufacturing a foam tray for food packaging laminates the first foaming layer and the second foaming layer while continuously foaming and extruding the first foaming layer and the second foaming layer without separate connecting facilities or connecting processes, and as a result, advantageous effects in terms of process costs and process simplification may be obtained.

The manufacturing method includes preparing a composition for preparing a first foaming layer including a biodegradable polymer in approximately 50% by weight to approximately 90% by weight; and preparing a composition for preparing a second foaming layer including a biodegradable polymer in approximately 95% by weight to approximately 100% by weight.

The composition for preparing a first foaming layer may further include starch in approximately 10% by weight to approximately 50% by weight, and descriptions on the biodegradable polymer and the starch are the same as the descriptions made above.

The composition for preparing a first foaming layer and the composition for preparing a second foaming layer may further include a foaming agent. By the composition further including a foaming agent, the first foaming layer and the second foaming layer may be prepared using a method of continuous foaming and extrusion, and through the foaming, the first foaming layer may form a bubble structure advantageous for absorbing moisture produced inside, and the second foaming layer may form a bubble structure advantageous for blocking moisture penetrating from the outside and enhancing strength against external shock.

The foaming agent may include one or more selected from the group consisting of hydrocarbon series foaming agents such as pentane gas, propane gas, Freon gas and butane gas, inert gas such as carbon dioxide, nitrogen and helium, and combinations thereof.

For example, the foaming agent may include carbon dioxide, and this is advantageous for the first foaming layer and the second foaming layer to form a target bubble structure, and an excellent effect may be obtained in terms that carbon dioxide-included foaming agent is an environmental-friendly foaming agent without a risk of explosion.

The composition for preparing a first foaming layer and the composition for preparing a second foaming layer may include the foaming agent in the content of approximately 1% by weight to approximately 5% by weight.

When the foaming agent is included in less than approximately 1% by weight, the first foaming layer and the second foaming layer do not form a bubble structure suitable for each function, and foam magnification may not be sufficiently secured. When the foaming agent is included in greater than approximately 5% by weight, dispersion of the foaming agent and process control are difficult, which leads to a problem of making a uniform bubble structure difficult.

The manufacturing method includes injecting the composition for preparing a first foaming layer to a first extruder, and injecting the composition for preparing a second foaming layer to a second extruder.

Specifically, an extruder having a structure vertically connecting the first extruder and the second extruder is prepared, the composition for preparing a first foaming layer is injected to the first extruder, and at the same time, the composition for preparing a second foaming layer may be injected to the second extruder.

The manufacturing method includes preparing a first foaming layer and a second foaming layer by continuously foaming and extruding the composition for preparing a first foaming layer and the composition for preparing a second foaming layer, respectively, and simultaneously laminating the first foaming layer and the second foaming layer.

In the step, the first foaming layer composition and the second foaming layer composition are continuously foamed and extruded to be prepared to the first foaming layer and the second foaming layer, respectively, and at the same time, the first foaming layer and the second foaming layer may be laminated in a manner of being connected without using a separate connecting process or an adhesive, and discharged. Specifically, the first foaming layer and the second foaming layer are connected by the heat they have themselves after the extrusion and prior to the cooling, and as a result, a laminated structure may be obtained without a separate connecting process.

Consequently, the manufacturing method may reduce manufacturing costs of the foam tray, and simplify the process. In addition, the foam tray includes tightly connected first foaming layer and second foaming layer without including an adhesive that contains substances harmful to the human body and the environment, and as a result, excellent durability required for food distribution or storage may be secured.

The composition for preparing a first foaming layer and the composition for preparing a second foaming layer may include an identical biodegradable polymer, and in this case, an effect of enhancing connecting power may be obtained when the first foaming layer and the second foaming layer are extruded and connected at the same time. In addition, the foam tray may be buried in the soil without a process of separating each layer when disposed, and may be disposed environmentally friendly.

When continuously foaming and extruding the composition for preparing a first foaming layer and the composition for preparing a second foaming layer, the first extruder and the second extruder may have cylinder temperatures of approximately 140° C. to approximately 230° C. When the cylinder temperatures of the first and the second extruders are lower than approximately 140° C., the compositions for preparing first and second foaming layers are not sufficiently melted leading to a problem of processibility decline, and when the temperatures are higher than approximately 230° C., sufficient foam magnification is difficult to secure and the biodegradable polymer resin is pyrolyzed, which may cause problems of not securing a moisture absorbent or blocking property and durability of the foam tray.

Hereinafter, specific examples of the present disclosure will be provided. However, the examples described below are only for specifically illustrating or describing the present disclosure, and the scope of the present disclosure is not limited thereto.

### EXAMPLE AND COMPARATIVE EXAMPLE

### Example 1

A foam tray including a laminated structure of a first foaming layer including corn starch (Samyang Genex Corporation) in 20% by weight and polylactic acid (NatureWorks LLC) in 80% by weight, and a second foaming layer including polylactic acid (NatureWorks LLC) in 100% by weight was manufactured.

### Comparative Example 1

A foam tray was manufactured in the same manner as in Example 1 except that the first foaming layer included polylactic acid in 100% by weight.

### Comparative Example 2

A single layer foam tray including polystyrene (Kumho Petrochemical Co., Ltd.) in 100% by weight was manufactured.

### Comparative Example 3

A foam tray including a laminated structure of a first foaming layer including polystyrene (Kumho Petrochemical Co., Ltd.) in 100% by weight, and a second foaming layer including a polyethylene terephthalate resin in 100% by weight was manufactured.

### Evaluation

### Test Example 1

### Moisture Absorptivity Measurement

The foam trays of the examples and the comparative examples were dried for 24 hours in an oven at 50° C., and the weights were measured to obtain ‘weight prior to moisture absorption’. Subsequently, the foam trays were immersed into water at room temperature for 12 hours to absorb water, and ‘weight after moisture absorption’ was measured. Then, moisture absorptivity was calculated using the following general formula, and the results are shown in Table 1.

Moisture absorptivity (%)={(weight after moisture absorption-weight prior to moisture absorption)/weight prior to moisture absorption}×100 [General Formula]

TABLE 1

| Category | After 12 Hours, Moisture Absorptivity [%] |
|---|---|
| Example 1 | 15.5 |
| Comparative | 7.3 |
| Example 1 | |
| Comparative | 4.4 |
| Example 2 | |
| Comparative | 4.8 |
| Example 3 | |

As shown in Table 1, in Example 1, the first foaming layer included both starch and a biodegradable polymer, and it was seen that moisture absorptivity was 15.5%, which was high of 10% or higher.

Meanwhile, in Comparative Example 1, the first foaming layer did not include starch, and both the first foaming layer and the second foaming layer included only PLA, and it was seen that moisture absorptivity was 7.3%, which was low compared to Example 1.

In addition, the foam tray of Comparative Example 2 was a single layer foam tray, and did not include a biodegradable polymer and starch at all. In Comparative Example 2, moisture absorptivity was 4.4%, which was significantly low compared to Example 1, and as a result, it was seen that almost no effects were obtained in absorbing moisture produced inside the foam tray, and since a biodegradable polymer was not included at all, it was seen that environmental-friendly effects were not obtained when disposed.

The foam tray of Comparative Example 3 had a laminated structure, however, the first foaming layer and the second foaming layer did not include a biodegradable polymer and starch. It was seen that Comparative Example 3 exhibited high moisture absorptivity compared to Comparative Example 2 but had a significantly inferior moisture absorbent property compared to Example 1. In addition, the second foaming layer did not include a biodegradable polymer at all, and it was seen that environmental-friendly effects were not obtained when disposed.

In other words, the foam tray for food packaging may exhibit an excellent moisture absorbent property by including a laminated structure of a first foaming layer and a second foaming layer, and the first foaming layer and the second foaming layer including a biodegradable polymer or starch. As a result, the foam tray for food packaging may effectively maintain freshness of meat or seafood that may produce moisture or blood during food distribution, and may be buried and degraded without a separation process when disposed, and environmental-friendly effects may be obtained.

The foam tray for food packaging is suitable for packing meat or seafood that may produce moisture or blood during the distribution, is harmless to the human body, and exhibits environmental-friendly effects.

The method for manufacturing a foam tray for food packaging is capable of preparing a foam tray having excellent strength and a moisture absorbent property while simplifying the manufacturing process.

### REFERENCE NUMERAL

100: Foam Tray for Food Packaging
110: First Foaming Layer
120: Second Foaming Layer
d1: Thickness of First Foaming Layer
d2: Thickness of Second Foaming Layer

What is claimed is:

1. A foam tray for food packaging comprising a laminated structure of a first foaming layer having an internal moisture absorbent property, and a second foaming layer having an external moisture barrier property,
wherein the first foaming layer and the second foaming layer include a biodegradable polymer.

2. The foam tray for food packaging of claim 1, wherein the first foaming layer includes the biodegradable polymer in 50% by weight to 90% by weight, and includes starch in 10% by weight to 50% by weight.

3. The foam tray for food packaging of claim 2, wherein the starch includes one or more selected from the group consisting of corn starch, wheat starch, sweet potato starch, rice starch, potato starch, tapioca starch and a combination thereof.

4. The foam tray for food packaging of claim 1, wherein the second foaming layer includes the biodegradable polymer in 95% by weight to 100% by weight.

5. The foam tray for food packaging of claim 1, wherein the biodegradable polymer is one or more selected from the group consisting of polylactic acid (PLA), polyhydroxyalkanoate (PHA), polybutylene succinate (PBS), polybutylene ad ipate-co-butyrene succinate (PBSA), polybutylene adipate terephthalate (PBAT), polyhydroxybutyrate valerate (PHBV), polyvinyl alcohol (PVA), polyglycolic acid (PGA), poly(ester-amide) (PEA), poly(ester-urethane) (PEU) and a combination thereof.

6. The foam tray for food packaging of claim 1, wherein the first foaming layer and the second foaming layer include an identical biodegradable polymer.

7. The foam tray for food packaging of claim 1, wherein the first foaming layer has a thickness of 1 mm to 3 mm.

8. The foam tray for food packaging of claim 1, wherein the second foaming layer has a thickness of 1 mm to 3 mm.

9. The foam tray for food packaging of claim 1, wherein the first foaming layer has an independent bubble fraction of 50% to 80%.

10. The foam tray for food packaging of claim 1, wherein the second foaming layer has an independent bubble fraction of 70% to 95%.

11. A method for manufacturing a foam tray for food packaging, the method comprising:
preparing a composition for preparing a first foaming layer including a biodegradable polymer in approximately 50% by weight to approximately 90% by weight;
preparing a composition for preparing a second foaming layer including a biodegradable polymer in approximately 95% by weight to approximately 100% by weight;
injecting the composition for preparing a first foaming layer to a first extruder, and injecting the composition for preparing a second foaming layer to a second extruder; and
preparing a first foaming layer and a second foaming layer by continuously foaming and extruding the composition for preparing a first foaming layer and the composition for preparing a second foaming layer, respectively, and simultaneously laminating the first foaming layer and the second foaming layer.

12. The method for manufacturing a foam tray for food packaging of claim 11, wherein the composition for preparing a first foaming layer further includes starch in 10% by weight to 50% by weight.

13. The method for manufacturing a foam tray for food packaging of claim 11, wherein the composition for preparing a first foaming layer and the composition for preparing a second foaming layer further include a foaming agent in 1% by weight to 5% by weight.

14. The method for manufacturing a foam tray for food packaging of claim 11, wherein the composition for preparing a first foaming layer and the composition for preparing a second foaming layer include an identical biodegradable polymer.

15. The method for manufacturing a foam tray for food packaging of claim 11, wherein the first extruder and the second extruder have cylinder temperatures of 140° C. to 230° C.
